(19) United States
(12) Patent Application Publication
(10) Pub. No.: US 2025/0242297 A1
(43) Pub. Date: Jul. 31, 2025

(54) SYSTEM AND METHOD FOR INSTALLATION OF A CORRUGATED SCREEN PACKING ASSEMBLY

(71) Applicant: NUOVO PIGNONE TECNOLOGIE S.r.l., Florence (IT)

(72) Inventor: Augusta Pedacchia, Sezze (Lt) (IT)

(21) Appl. No.: 18/428,640

(22) Filed: Jan. 31, 2024

(51) Int. Cl. B01D 53/18; B01D 53/14; B01J 19/30

(52) U.S. Cl. CPC B01D 53/18; B01D 53/1475; B01J 19/305; B01D 2257/504

(57) ABSTRACT

An absorption column includes an outer wall, a floor connected to the outer wall and a ceiling connected to the outer wall, a support ring disposed on an inner surface of the outer wall, and a corrugated screen packing module supported on the support ring. The corrugated screen packing module includes a corrugated screen layer including a plurality of corrugated structures, each of the corrugated structures being configured and dimensioned to pass through an access opening having a first area A1. The first area A1 is smaller than a second area A2 defined by the inner surface of the outer wall in a plane perpendicular to a longitudinal axis of the absorption column.

### BACKGROUND

Various manufacturing and chemical systems, e.g., oil refineries, produce flue gases including carbon dioxide. While the flue gases from these systems may be exhausted into the atmosphere, it is desirable to remove the carbon dioxide from the flue gases prior to exhausting into the atmosphere. Such removal is referred to as carbon capture. Improvements to carbon capture systems that perform carbon capture may be desirable.

### SUMMARY

An embodiment of an absorption column defining a longitudinal axis and including an outer wall, a floor connected to the outer wall and a ceiling connected to the outer wall, a support ring disposed on an inner surface of the outer wall, and a corrugated screen packing module supported on the support ring, wherein the corrugated screen packing module comprises a corrugated screen layer comprising a plurality of corrugated structures, each of the corrugated structures being configured and dimensioned to pass through an access opening having a first area A1, and wherein the first area A1 is smaller than a second area A2 defined by the inner surface of the outer wall in a plane perpendicular to the longitudinal axis.

An embodiment of a method of assembling a corrugated screen packing module comprising a corrugated screen layer comprising a plurality of corrugated structures within an absorption column that defines a longitudinal axis, including passing each of the corrugated structures through an access opening having an area A1 formed in a ceiling, a floor, or an outer wall of the absorption column, and assembling the corrugated screen packing layer from the corrugated structures within the absorption column, the corrugated screen packing module being disposed on a support ring disposed on an inner surface of the outer wall of the absorption column, wherein the first area A1 is smaller than a second area A2 defined by the inner surface of the outer wall in a plane perpendicular to the longitudinal axis.

An embodiment of a carbon capture system, including an absorption column defining a longitudinal axis and configured to receive a gas comprising a substance to be absorbed, for example, carbon dioxide and a solvent and induce the gas comprising the substance to be absorbed into the solvent, and a stripper column configured to receive the solvent with the desired substance absorbed therein from the absorption column and separate the desired substance therefrom and return the solvent with the desired substance separated therefrom to the absorption column, wherein the absorption column includes an outer wall, a floor connected to the outer wall, and a ceiling connected to the inner wall, a support ring disposed on an inner surface of the outer wall, and a corrugated screen packing module disposed on the support ring, and wherein the corrugated screen packing module comprises a corrugated screen layer comprising a plurality of corrugated structures, each of the corrugated structures being configured and dimensioned to pass through an access opening having a first area A1, and wherein the first area A1 is smaller than a second area A2 defined by the inner surface of the outer wall in a plane perpendicular to the longitudinal axis.

### BRIEF DESCRIPTION OF THE DRAWINGS

The following descriptions should not be considered limiting in any way. With reference to the accompanying drawings, like elements are numbered alike:

FIG. 1 shows a simplified schematic diagram of a carbon capture system according to one or more embodiments;

FIG. 2 shows an absorption column according to one or more embodiments;

FIG. 2A shows a cross-sectional view of a manhole taken at 2A-2A in FIG. 2;

FIG. 2B shows a cross-sectional view of the absorption column taken at 2B-2B in FIG.

FIG. 3 shows an upper view of a corrugated screen packing module from the cross-section taken at 3-3 in FIG. 2:

FIG. 4 shows a bottom view of a corrugated screen packing module from the cross-section taken at 4-4 in FIG. 2;

FIG. 5 shows a side cross-sectional view of a corrugated screen packing module from the cross-section taken at 5-5 in FIG. 3;

FIG. 6 shows a view of a corrugated screen layer according to one or more embodiments;

FIG. 7 shows a flowchart of a process of forming an absorption column with a corrugated screen packing assembly according to one or more embodiments; and

FIG. 8 shows a schematic cross-sectional view of an absorption column according to one or more embodiments.

### DETAILED DESCRIPTION

A detailed description of one or more embodiments of the disclosed apparatus and method are presented herein by way of exemplification and not limitation with reference to the Figures.

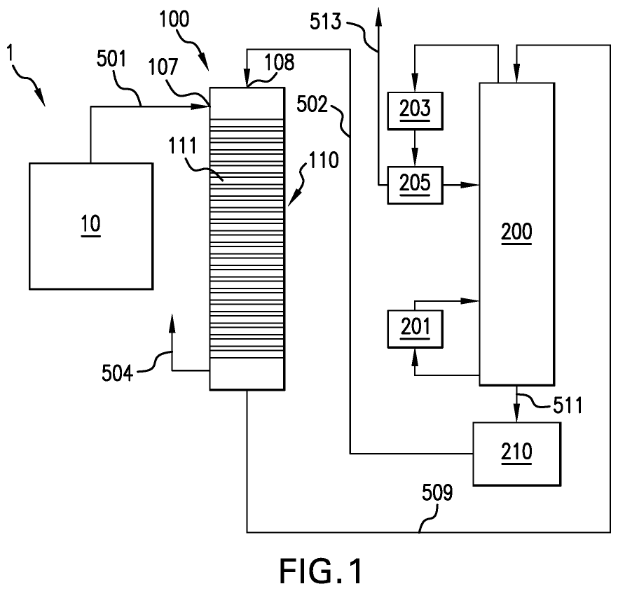

A simplified schematic diagram of a carbon capture system 1 according to one or more embodiments is shown in FIG. 1. The carbon capture system 1 may include a manufacturing or chemical system 10 that produces flue gases that include carbon dioxide. The manufacturing or chemical system 10 may be an oil refinery.

The carbon capture system 1 further includes an absorption column 100. The absorption column 100 may be a regenerative froth contactor (RFC) equipped with a corrugated screen packing assembly 110 that includes a plurality of corrugated screen packing modules 111. A flue gas line 501 may extend from a flue gas outlet of the manufacturing or chemical system 10 to a flue gas inlet 107 of the absorption column 100. The flue gas inlet 107 may be disposed at or near an upstream portion of the absorption column 100. The flue gas inlet 107 may be disposed upstream of an entirety of the corrugated screen packing assembly 110.

The carbon capture system 1 may further include a solvent tank 210. The solvent tank 210 may store a liquid solvent. The liquid solvent may be an amine, amino acid salts, carbonate systems, aqueous ammonia, immiscible liquids, ionic liquids, or another liquid solvent known in the art that is effective for carbon capture. As explained below, the liquid solvent within the solvent tank 210 may be a lean liquid solvent. A lean solvent line 502 may extend from a lean solvent outlet of the solvent tank 210 to a lean solvent inlet 108 of the absorption column 100. The lean solvent inlet 108 may be disposed at or near an upstream portion of the absorption column 100. The lean solvent inlet 108 may be disposed upstream of an entirety of the corrugated screen packing assembly 110.

As explained above, the flue gas inlet 107 and the lean solvent inlet 108 may be disposed at or near an upstream portion of the absorption column 100 upstream of the corrugated screen packing assembly 110. As such, the absorption column 100 may induce co-current flow of the flue gas from the flue gas inlet 107 and the lean solvent from the lean solvent inlet 108 downstream through the corrugated screen packing assembly 110. That is, the absorption column 100 may include a co-current contactor system in the form of the corrugated screen packing assembly 110. The co-current flow of the flue gas and the lean solvent through the corrugated screen packing assembly 110 may result in carbon dioxide in the flue gas being absorbed into the solvent, removing the carbon dioxide from the flue gas and forming a rich solvent having carbon dioxide absorbed therein.

The absorption column 100 may include a gas outlet fluidly connected to a gas exhaust line 504 and a rich solvent outlet fluidly connected to a rich solvent line 509. The flue gas with the carbon dioxide removed may be removed from the carbon capture system 1 via the gas exhaust line 504.

The carbon capture system 1 may further include a stripper column 200. The rich solvent line 509 may extend from the rich solvent outlet of the absorption column 100 to a rich solvent inlet of the stripper column 200. The rich solvent may be pumped from the absorption column 100 to the stripper column 200. The rich solvent may be heated, for example by a heat exchanger, prior to being fed into the stripper column 200. The carbon capture system 1 may further include a solvent line 511 extending from a solvent outlet of the stripper column 200 to a solvent inlet of the solvent tank 210.

The stripper column 200 may be a stripper column known in the art for separating carbon dioxide from the rich solvent containing carbon dioxide. As a non-limiting example, the stripper column 200 may include packing material (not shown), while a reboiler 201, a condenser 203, and a reflux drum 205 may be connected to the stripper column 200. The rich solvent fed into the rich solvent inlet of the stripper column 200 may fall due to gravity over the packing material to an end portion of the stripper column 200 where the solvent may be fed into the reboiler 201. While FIG. 1 shows a separate line from the solvent line 511 feeding into the reboiler 201, the line feeding into the reboiler 201 may branch from the solvent line 511. The reboiler 201 may heat the solvent such that water in the solvent is turned steam and fed back into the stripper column 200. The steam and the carbon dioxide may rise to an end portion of the stripper column 200 and run through the condenser 203 where the steam and carbon dioxide are cooled to form liquid water and gaseous carbon dioxide and fed into the reflux drum 205. The water may be fed from the reflux drum 205 back into the stripper column 200 and mixed with the solvent at an end portion of the stripper column 200 and/or at the solvent tank 210. Thus, lean solvent is fed into the solvent tank 210 and subsequently cycled back into the absorption column 100 as explained above. The gaseous carbon dioxide may be removed from the reflux drum 205 via a carbon dioxide line 513. The gaseous carbon dioxide may then be cooled into liquid and stored and/or used in other applications.

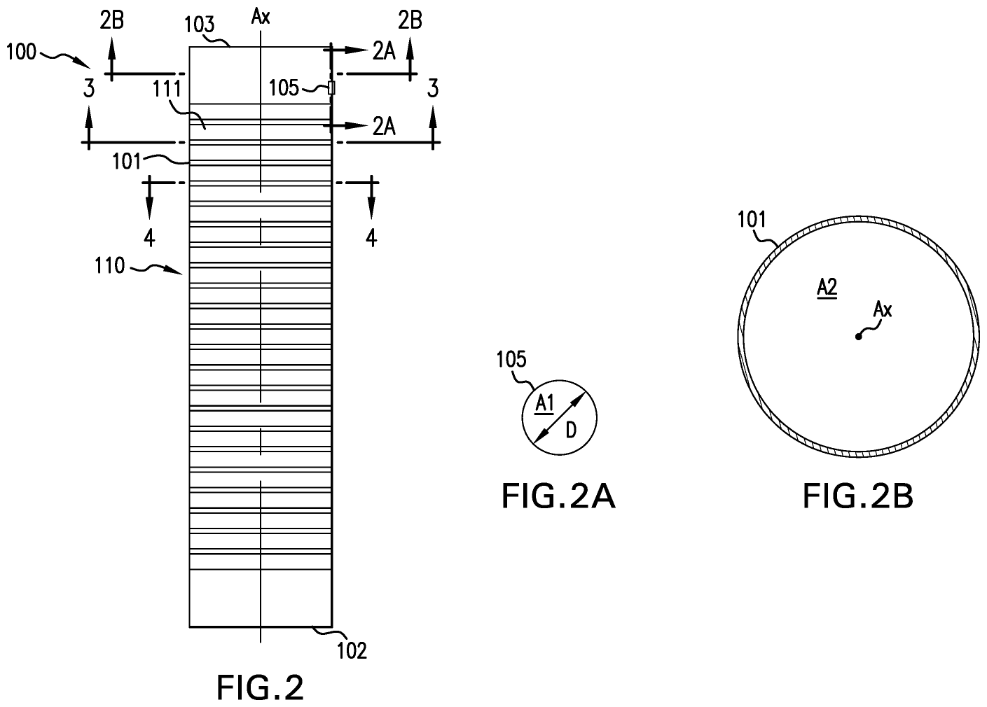

An absorption column 100 according to one or more embodiments is shown in FIG. 2. As explained above, the absorption column 100 may be a RFC equipped with a corrugated screen packing assembly 110 that includes a plurality of corrugated screen packing modules 111. The absorption column 100 may be cylindrical and include an outer wall 101 that is annular with a circular cross-section. While the absorption column 100 is cylindrical in the example shown in FIG. 2, the absorption column may be any other shape, including but not limited to a hexagonal, a rectangular, or a triangular column. The absorption column 100 defines a longitudinal axis Ax. The corrugated screen packing modules 111 may be disposed within the outer wall 101 and stacked in a longitudinal direction of the absorption column 100. As shown in FIGS. 1 and 2, the corrugated screen packing modules 111 may be spaced apart in the longitudinal direction. The corrugated screen packing modules 111 may be stacked together without space therebetween. The number of corrugated screen packing modules 111 in the corrugated screen packing assembly 110 is not limited in any way by the present disclosure, and may be selected as appropriate depending on application. A ceiling 103 may be disposed at an upstream end of the outer wall 101 of the absorption column 100. The absorption column 100 may include at least a manhole 105 having a door, a hatch, or other access mechanism that may open to provide access to an inside of the absorption column 100. The manhole 105 may be an example of an access opening. While FIG. 2 shows the manhole 105 formed in the outer wall 101, the manhole 105 may be formed in the ceiling 103 or a floor 102 of the absorption column 100. The manhole 105 may be sized to be smaller than the ceiling 103.

FIG. 2A shows a cross-sectional view of the manhole 105 taken at 2A-2A in FIG. 2, and FIG. 2B shows a cross-sectional view of the absorption column 100 taken at 2B-2B in FIG. 2. The manhole 105 defines an internal diameter D and defines a first area A1 in a plane perpendicular to the longitudinal axis Ax of the absorption column. The absorption column 100 defines a second area A2 in a plane perpendicular to the longitudinal axis Ax. The manhole 105 may have an internal diameter in a range from 400 mm to 1200 mm. The manhole 105 may have an internal diameter D in a range from 400 mm to 650 mm. The manhole 105 may have an internal diameter D in a range from 450 mm to 600 mm. The manhole 105 may have an internal diameter D in a range from 500 mm to 600 mm. The manhole 105 may have an internal diameter D in a range from 550 mm to 600 mm. The manhole 105 may have an internal diameter D in a range from 560 mm to 580 mm. The manhole 105 may have an internal diameter D of 570 mm. The internal diameter is an example of a dimension of the manhole 105. The area A1 defined by the manhole 105 is smaller than the area A2 defined by the absorption column 100.

The flue gas and the lean solvent fed into the absorption column 100 may travel downstream in a gas-liquid co-flow configuration, with a pulse regime hydrodynamic condition. Each of the corrugated screen packing modules 111 may be formed of convoluted screens that maximize the solvent pulsing effect while minimizing the metal packing material. The corrugated screen packing assembly 110 may induce the absorption column 100 to operate under a froth condition in two-phase flow with millions of bubbles and droplets being formed in the absorption column 100. The bubbles may be created as bands of froth collapse and are regenerated. The lean solvent in liquid phase and the flue gas in gaseous phase may be fed into the absorption column co-currently from the upstream portion, flow through corrugated screen packing assembly 110 in pulsing regime and disengage at the downstream portion of the absorption column 100. The pulse flow may occur due to a hydrodynamic multi-phase phenomenon depending on the flow rates and the design of the corrugated screen packing assembly 110. The gas may pass through multiple zones of froth along the corrugated screen packing assembly 110, and the carbon dioxide may get absorbed into the lean solvent.

According to one or more embodiments, the absorption column 100 may be a RFC equipped with a corrugated screen packing assembly 110 having no moving parts and may operate in a downward ‘co-flow’ configuration. The corrugated screen packing assembly may be formed of convoluted screens that may increase a solvent pulsing effect, and may decrease metal packing material, by inducing the absorption column 100 to operate under a transient froth condition in two phase flow. The pulse flow may be set up as a hydrodynamic multi-phase phenomenon, corresponding to a specific region in a flow map within the absorption column 100. Mass transfer may take place in pulses of froth formed by gas and liquid. As bands of froth propagate down the absorption column 100, the absorber enables a high contact surface area and excellent mixing, reducing or eliminating resistance of diffusivity film over the packing surface, replaced by millions of bubbles and droplets, created as bands of froth collapse and are regenerated. The carbon dioxide may thus be transferred from the gas into the liquid phase in the froth in a whole volume of the absorption column 100, while the corrugated screen packing assembly 100 may govern the froth. The applicable flow map may depend on characteristics of fluids and selected geometry of the corrugated screen packing assembly 110. For some gas/liquid systems, a geometry of the corrugated screen packing assembly 110 may be selected to enforce a preferred pulse area on the flow map and a coarser or thinner froth, through effects of the corrugated screen packing assembly 100 on the hydrodynamic regime.

An absorption column 100 may enable accommodation of high gas flow rates and liquid/gas ratios, without excessive back pressure or flooding within the absorption column 100. The absorption column 100 may also be used in processes with precipitating solvents or high levels of entrained solids, leading to three-phase contactors. The absorption column 100 may experience minimal or no fouling or additional pressure drop penalty, even under high particulate loads and high viscosity.

While a non-limiting example of an oil refinery is mentioned above for the manufacturing or chemical system 10, carbon capture system 1 may be applicable to various carbon capture platforms including, for example, natural gas treatment, post-combustion capture, air pollution control, indoor air quality management, and direct air capture.

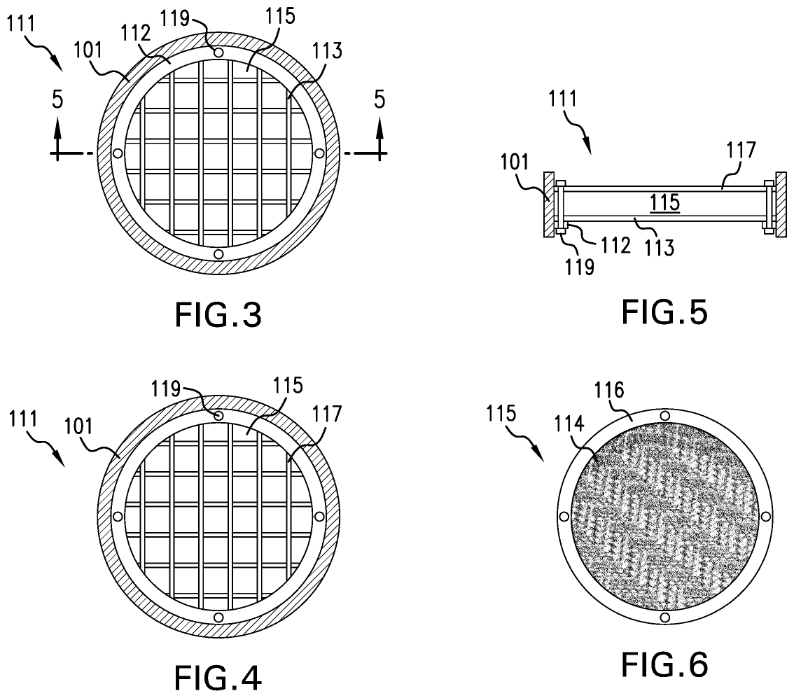

FIG. 3 shows a view of a corrugated screen packing module 111 from the cross-section taken at 3-3 in FIG. 2, and FIG. 4 shows a view of a corrugated screen packing module 111 according to one or more embodiments from the cross-section taken at 4-4 in FIG. 2. FIG. 5 shows a side cross-sectional view of a corrugated screen packing module 111 according to one or more embodiments from the cross-section taken at 5-5 in FIG. 3. The corrugated screen packing module 111 may be disposed within the outer wall 101 of the absorption column 100, and may include a support ring 1112, a first grid layer 113, a corrugated screen layer 115, a second grid layer 117, and a fastener 119. The first grid layer 113 may be a lower grid layer and the second grid layer 117 may be an upper grid layer.

The support ring 112 may be formed integrally with an inner surface of the outer wall 101 of the absorption column or may be welded to an inner surface of the outer wall 101 of the absorption column. The absorption column 100 may be manufactured with the support ring 112. The support ring 112 may be added subsequent to the absorption column being manufactured. The support ring 112 may be larger than an opening of the manhole 105 formed in the ceiling 103, the outer wall 101, or the floor 102 of the absorption column 100 (see FIG. 2). The support ring 112 may include a plurality of fastener holes through which the fastener 119 may pass. The support ring 112 can be a whole annular structure or can have grooves or other kinds of separations.

The first grid layer 113 may be mounted on the support ring 112. The first grid layer 113 may be formed of a plurality of rods arranged in a grid pattern. The first grid layer 113 may further include an outer ring around the periphery of the rods in the grid pattern. According to one or more embodiments, the outer ring of the first grid layer 113 may be formed of multiple segments, each of which may be configured to pass through the manhole 105 formed in the ceiling 103, the outer wall 101, or the floor 102 of the absorption column 100 (see FIG. 2). The outer ring may include a plurality of fastener holes through which the fastener 119 may pass. The rods of the first grid layer 113 may be arranged in the grid pattern directly on the support ring 112 without the outer ring, with the rods supported directly by the support ring 112. Each of the rods of the first grid layer 113 may be configured to pass through the manhole 105 formed in the ceiling 103, the outer wall 101, or the floor 102 of the absorption column 100 (see FIG. 2).

The corrugated screen layer 115 may be mounted on the first grid layer 113. A corrugated screen layer 115 is shown in FIG. 6, The corrugated screen layer 115 may be formed of a plurality of corrugated structures 114. Each of the corrugated structures 114 may be configured to pass through the manhole 105 formed in the ceiling 103, the outer wall 101, or the floor 102 of the absorption column 100 (see FIG. 2). The corrugated screen layer 115 may further include an outer ring 116 around the periphery of the corrugated structures 114, The outer ring of the corrugated screen layer 115 may be formed of multiple segments, each of which may be configured to pass through the manhole 105 formed in the ceiling 103, the outer wall 101, or the floor 102 of the absorption column 100 (see FIG. 2). The corrugated structures 114 may be mounted directly on the first grid layer 113 without the outer ring 116. The corrugated structures 114 of the corrugated screen may be fastened or welded together.

The second grid layer 117 may be mounted on the corrugated screen layer 115. The second grid layer 117 may be formed of a plurality of rods arranged in a grid pattern. The second grid layer 117 may further include an outer ring around the periphery of the rods in the grid pattern. The outer ring of the second grid layer 117 may be formed of multiple segments, each of which may be configured to pass through the manhole 105 formed in the ceiling 103, the outer wall 101, or the floor 102 of the absorption column 100 (see FIG. 2). The outer ring may include a plurality of fastener holes through which the fastener 119 may pass. The rods of the second grid layer 117 may be arranged in the grid pattern directly on the corrugated screen layer 115 without the outer ring. Each of the rods of the second grid layer 117 may be configured to pass through the manhole 105 formed in the ceiling 103, the outer wall 101, or the floor 102 of the absorption column 100 (see FIG. 2).

While the first grid layer 113 and the second grid layer 117 may be formed of a plurality of rods arranged in a grid pattern as explained above, the first grid layer 113 and the second grid layer 117 may be formed of bars or other structures in a grid pattern.

A plurality of fasteners 119 may secure the support ring 112, the first grid layer 113, the corrugated screen layer 115, and the second grid layer 117 together. The fasteners 119 may be, for example, rivets, bolt-and-nut structures, or other fasteners known in the art. The fasteners 119 may be passed through fastener holes formed in each of the support ring 112, the first grid layer 113, the corrugated screen layer 115, and the second grid layer 117 to fasten them together. While FIG. 3 shows four fasteners 119, the present disclosure is not limited thereto, and the corrugated screen packing module 111 may include any number of fasteners 119.

The corrugated screen packing assembly 110 may further include support beams (not shown) extending between corrugated screen modules 111, with the first grid layer 113 of one corrugated screen packing module 111 and the second grid layer 117 of another corrugated screen packing module 111, The support beams may extend through one or more of the corrugated screen modules 111. One support beam may support a single corrugated screen module 111 or multiple corrugated screen modules 111.

The use of the support rings 112 may allow separation or concentration, as desired, of the corrugated screen packing assembly 110 in view of requirements of the absorption column 100 to separate the carbon dioxide from the flue gas.

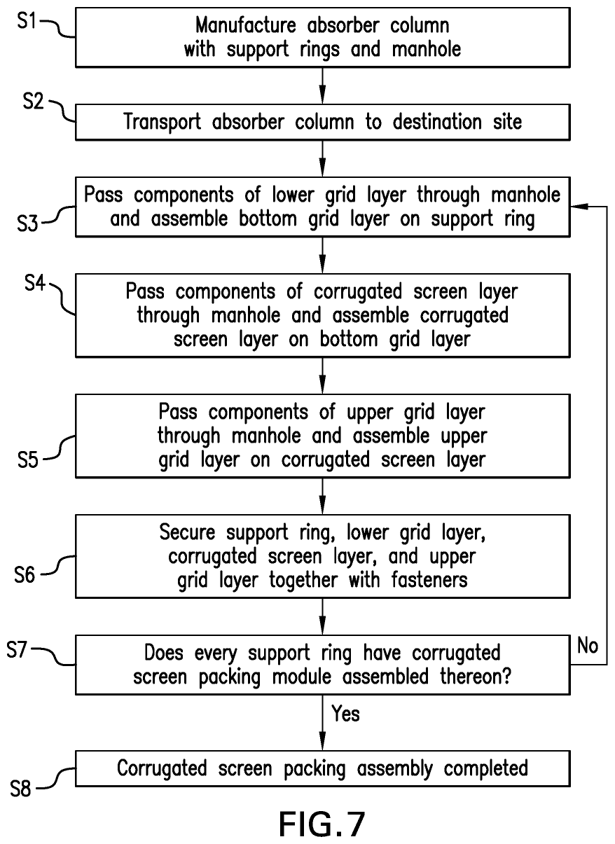

A process of forming an absorption column 100 with a corrugated screen packing assembly 110 according to one or more embodiments is shown in FIG. 7. In Step S1, the absorption column 100 may be manufactured with an outer wall 101 that is annular, a ceiling 103 on the outer wall 101, a manhole 105 in the ceiling 103, the outer wall 101, or a floor 102 of the absorption column 100, and support rings 112 on an inner surface of the outer wall 101. In Step S2, the absorption column 100 may be transported to a destination site where the corrugated screen packing assembly 110 is to be installed onto the absorption column 100.

In Step S3, components of a first grid layer 113 may be passed through the manhole 105 formed in the ceiling 103, the outer wall 101, or the floor 102 of the absorption column 100, then assembled within the absorption column 100 such that the assembled first grid layer 113 is mounted on one of the support rings 112.

In Step S4, components of a corrugated screen layer 115 may be passed through the manhole 105 formed in the ceiling 103, the outer wall 101, or the floor 102 of the absorption column 100, then assembled within the absorption column 100 such that the assembled corrugated screen layer 115 is mounted on the assembled first grid layer 113.

In Step S5, components of a second grid layer 117 may be passed through the manhole 105 formed in the ceiling 103, the outer wall 101, or the floor 102 of the absorption column 100, then assembled within the absorption column 100 such that the assembled second grid layer 117 is mounted on the assembled corrugated screen layer 115.

In Step S6, the support ring 112, the first grid layer 113, the corrugated screen layer 115, and the second grid layer 117 may be fastened together via fasteners 119. In Step S7, a determination may be made whether every support ring 112 of the absorption column 100 has a corrugated screen packing module 111 assembled thereon. If no at Step S7, the process may be repeated starting at Step S3. If yes at Step S7, the process may proceed to Step S8, and assembly of the corrugated screen packing assembly 110 within the absorption column 100 may be completed.

While Steps S1 and S2 recite manufacturing the absorption column 100 with support rings 112 then transporting the absorption column 100 to a destination site, the present disclosure is not limited thereto. For example, the support rings 112 may be designed as smaller segments that, at the destination site, may be passed through the manhole 105 and assembled within the absorption column 100, being welded onto the inner surface of the outer wall 101 of the absorption column.

While Step S7 inquires whether every support ring 112 of the absorption column 100 has a corrugated screen packing module 111 assembled thereon, the present disclosure is not limited thereto. For example, if a specific application of the absorption column 100 requires or is operable with less than a maximum number of corrugated screen packing modules 111 that the support rings 112 can support, the determination at Step 7 may inquire whether every support ring 112 intended to have corrugated a screen packing module 111 thereon has a corrugated a screen packing module 111 assembled thereon.

As the assembled first grid layer 113, the assembled corrugated screen layer 115, and the assembled second grid layer 117 may be larger than the manhole 105, the first grid layer 113, the corrugated screen layer 115, and the second grid layer 117 may be designed as a plurality of components, each of which is sufficiently small to pass through the manhole 105 and configured to be assembled inside the absorption column 100. One or more embodiments disclosed herein may allow for installation of the corrugated screen packing assembly 110 on different absorption columns 100 having differing diameters. One or more embodiments disclosed herein may allow for installation of the corrugated screen packing assembly 110 in the absorption column 100 by a standard installation crew. As components of the corrugated screen packing assembly 110 may have a shorter life than the absorption column 100, one or more embodiments disclosed herein may allow for replacement of components of the corrugated screen packing assembly 110 or replacement of entire corrugated screen packing modules 111 by passing components thereof through the manhole 105 and assembling and installing within the absorption column 100.

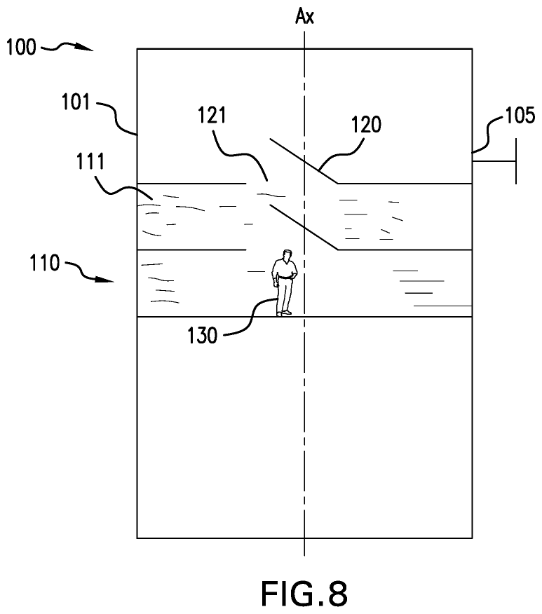

FIG. 8 shows an absorption column 100 according to one or more embodiments. In the absorption column 100 shown in FIG. 8, one or more of the corrugated screen packing modules 111 of the corrugated screen packing assembly 110 may include a module access structure 120 that defines a module access opening 121. For example, the module access structure 120 may be a hatch or a door that, when opened to expose the module access opening 121, may allow a person 130 to pass through the corrugated screen packing module 11. The module access structure 120 and the module access opening 121 may be formed on one, a plurality, or all of the corrugated screen packing modules 111 of the corrugated screen packing assembly 110. One or more of the corrugated screen packing modules 111 of the corrugated screen packing assembly 110 may include a plurality of module access structures 120 that define a plurality of module access openings 121. The module access opening 121 may have an internal diameter in a range from 400 mm to 1200 mm. The module access opening 121 may have an internal diameter in a range from 400 mm to 650 mm. The module access opening 121 may have an internal diameter in a range from 450 mm to 600 mm. The module access opening 121 may have an internal diameter in a range from 500 mm to 600 mm. The module access opening 121 may have an internal diameter in a range from 550 mm to 600 mm. The module access opening 121 may have an internal diameter in a range from 560 mm to 580 mm. The module access opening 121 may have an internal diameter of 570 mm. The internal diameter is an example of a dimension of the module access opening 121.

While an absorption column 100 is described above in the context of a carbon capture system 1, this is merely set forth as an example, and the absorption column 100 is not limited thereto. That is, the absorption column 100 may be used in other systems. For example, the absorption column 100 may be used in a system that removes any other compound from flue gas, including but not limited to corrosive gaseous emissions, acidic fumes, odors, sulfur dioxide, and carbon monoxide. The absorption column 100 may also be used in any application that includes gas-liquid absorption.

Set forth below are some aspects of the foregoing disclosure:

Embodiment 1: An absorption column including an outer wall, a floor connected to the outer wall and a ceiling connected to the outer wall, a support ring disposed on an inner surface of the outer wall, and a corrugated screen packing module supported on the support ring, wherein the corrugated screen packing module comprises a corrugated screen layer comprising a plurality of corrugated structures, each of the corrugated structures being configured and dimensioned to pass through an access opening having a first area A1, and wherein the first area A1 is smaller than a second area A2 defined by the inner surface of the outer wall in a plane perpendicular to the longitudinal axis.

Embodiment 2: The absorption column as in any prior embodiment, wherein the access opening has a set of dimensions including a dimension in a range from 400 mm to 1200 mm.

Embodiment 3: The absorption column as in any prior embodiment, wherein the absorption column comprises the access opening formed in the outer wall, the floor, or the ceiling.

Embodiment 4: The absorption column as in any prior embodiment, wherein the corrugated screen packing module comprises a first grid layer comprising a plurality of rods or bars arranged in a grid pattern, each of the plurality of rods or bars of the first grid layer being configured and dimensioned to pass through the access opening.

Embodiment 5: The absorption column of any prior embodiment, wherein the first grid layer also comprises an outer ring around the periphery of the rods in the grid pattern.

Embodiment 6: The absorption column as in any prior embodiment, wherein the corrugated screen packing module further comprises a second grid layer comprising a plurality of rods or bars arranged in a grid pattern, each of the plurality of rods or bars of the second grid layer being configured and dimensioned to pass through the access opening.

Embodiment 7: The absorption column of any prior embodiment, wherein the second grid layer also comprises an outer ring around the periphery of the rods in the grid pattern.

Embodiment 8: The absorption column as in any prior embodiment, wherein the absorption column is a regenerative froth contactor configured to induce co-current flow of gas and solvent through the corrugated screen packing module.

Embodiment 9: The absorption column as in any prior embodiment, wherein the dimension in the range from 400 mm to 1200 mm is a maximum dimension of the access opening.

Embodiment 10: A method of assembling a corrugated screen packing module comprising a corrugated screen layer comprising a plurality of corrugated structures within an absorption column that defines a longitudinal axis, including passing each of the corrugated structures through an access opening having an area A1 formed in a ceiling, a floor, or an outer wall of the absorption column, and assembling the corrugated screen packing layer from the corrugated structures within the absorption column, the corrugated screen packing module being disposed on a support ring disposed on an inner surface of the outer wall of the absorption column, wherein the first area A1 is smaller than a second area A2 defined by the inner surface of the outer wall in a plane perpendicular to the longitudinal axis.

Embodiment 11: The method as in any prior embodiment, wherein the access opening has a set of dimensions including a range in a range from 400 mm to 1200 mm.

Embodiment 12: The method as in any prior embodiment, wherein the corrugated screen packing module comprises a first grid layer comprising of a plurality of rods or bars arranged in a grid pattern, each of the plurality of rods or bars of the first grid layer being passed through the access opening and assembled in the absorption column.

Embodiment 13: The method as in any prior embodiment, wherein the corrugated screen packing module comprises a second grid layer comprising of a plurality of rods or bars arranged in a grid pattern, each of the plurality of rods or bars of the second grid layer being passed through the access opening and assembled in the absorption column.

Embodiment 14: The method as in any prior embodiment, further comprising fastening the support ring, the first grid layer, the corrugated screen layer, and the second grid layer together with a fastener.

Embodiment 15: The method as in any prior embodiment, wherein the dimension in the range from 400 mm to 1200 mm is a maximum dimension of the access opening.

Embodiment 16: A carbon capture system, including an absorption column defining a longitudinal axis and configured to receive gas comprising carbon dioxide and a solvent and induce the carbon dioxide to be absorbed into the solvent; and a stripper column configured to receive the solvent with the carbon dioxide absorbed therein from the absorption column and separate the carbon dioxide therefrom and return the solvent with the carbon dioxide separated therefrom to the absorption column, wherein the absorption column includes an outer wall, a floor connected to the outer wall, and a ceiling connected to the inner wall. a support ring disposed on an inner surface of the outer wall, and a corrugated screen packing module disposed on the support ring, and wherein the corrugated screen packing module comprises a corrugated screen layer comprising a plurality of corrugated structures, each of the corrugated structures being configured and dimensioned to pass through an access opening having a first area A1, and wherein the first area A1 is smaller than a second area A2 defined by the inner surface of the outer wall in a plane perpendicular to the longitudinal axis.

Embodiment 17: The carbon capture system as in any prior embodiment, wherein the access opening has a set of dimensions including a range in a range from 400 mm to 1200 mm.

Embodiment 18: The carbon capture system as in any prior embodiment, wherein the absorption column comprises the access opening formed in the outer wall, the floor, or the ceiling.

Embodiment 19: The carbon capture system as in any prior embodiment, wherein the corrugated screen packing module comprises a first grid layer, the first grid layer comprising a plurality of rods or bars arranged in a grid pattern, each of the plurality of rods or bars of the first grid layer being configured and dimensioned to pass through the access opening.

Embodiment 20: The carbon capture system as in any prior embodiment, wherein the dimension in the range from 400 mm to 1200 mm is a maximum dimension of the access opening.

Embodiment 21: The absorption column as in any prior embodiments, wherein the corrugated screen packing module comprises a module access opening formed therethrough.

Embodiment 22: The method as in any prior embodiments, wherein the corrugated screen packing module comprises a module access opening formed therethrough.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8%.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An absorption column comprising:
an outer wall, a floor connected to the outer wall and a ceiling connected to the outer wall;
a support ring disposed on an inner surface of the outer wall; and
a corrugated screen packing module supported on the support ring,
wherein the corrugated screen packing module comprises a corrugated screen layer comprising a plurality of corrugated structures, each of the corrugated structures being configured and dimensioned to pass through an access opening having a first area A1, and
wherein the first area A1 is smaller than a second area A2 defined by the inner surface of the outer wall in a plane perpendicular to a longitudinal axis of the absorption column.

2. The absorption column of claim 1, wherein the access opening has a set of dimensions including a dimension in a range from 400 mm to 1200 mm.

3. The absorption column of claim 1, wherein the absorption column comprises the access opening formed in the outer wall, the floor, or the ceiling.

4. The absorption column of claim 1, wherein the corrugated screen packing module comprises a first grid layer comprising a plurality of rods or bars arranged in a grid pattern, each of the plurality of rods or bars of the first grid layer being configured and dimensioned to pass through the access opening.

5. The absorption column of claim 4, wherein the first grid layer comprises an outer ring around a periphery of the rods in the grid pattern.

6. The absorption column of claim 4, wherein the corrugated screen packing module further comprises a second grid layer comprising a plurality of rods or bars arranged in a grid pattern, each of the plurality of rods or bars of the second grid layer being configured and dimensioned to pass through the access opening.

7. The absorption column of claim 6, wherein the second grid layer comprises an outer ring around a periphery of the rods in the grid pattern.

8. The absorption column of claim 1, wherein the absorption column is a regenerative froth contactor configured to induce co-current flow of gas and solvent through the corrugated screen packing module.

9. The absorption column of claim 2, wherein the dimension in the range from 400 mm to 1200 mm is a maximum dimension of the access opening.

10. A method of assembling a corrugated screen packing module comprising a corrugated screen layer comprising a plurality of corrugated structures within an absorption column that defines a longitudinal axis, comprising:
passing each of the corrugated structures through an access opening having an area A1 formed in a ceiling, a floor, or an outer wall of the absorption column, and
assembling the corrugated screen packing layer from the corrugated structures within the absorption column, the corrugated screen packing module being disposed on a support ring disposed on an inner surface of the outer wall of the absorption column,
wherein the first area A1 is smaller than a second area A2 defined by the inner surface of the outer wall in a plane perpendicular to the longitudinal axis.

11. The method of claim 10, wherein the access opening has a set of dimensions including a range in a range from 400 mm to 1200 mm.

12. The method of claim 10, wherein the corrugated screen packing module comprises a first grid layer comprising of a plurality of rods or bars arranged in a grid pattern, each of the plurality of rods or bars of the first grid layer being passed through the access opening and assembled in the absorption column.

13. The method of claim 12, wherein the corrugated screen packing module comprises a second grid layer comprising of a plurality of rods or bars arranged in a grid pattern, each of the plurality of rods or bars of the second grid layer being passed through the access opening and assembled in the absorption column.

14. The method of claim 13, further comprising fastening the support ring, the first grid layer, the corrugated screen layer, and the second grid layer together with a fastener.

15. The method of claim 10, wherein the dimension in the range from 400 mm to 1200 mm is a maximum dimension of the access opening.

16. A carbon capture system, comprising:
an absorption column defining a longitudinal axis and configured to receive gas comprising carbon dioxide and a solvent and induce the carbon dioxide to be absorbed into the solvent; and
a stripper column configured to receive the solvent with the carbon dioxide absorbed therein from the absorption column and separate the carbon dioxide therefrom and return the solvent with the carbon dioxide separated therefrom to the absorption column,
wherein the absorption column comprises:
an outer wall, a floor connected to the outer wall, and a ceiling connected to the inner wall;
a support ring disposed on an inner surface of the outer wall; and
a corrugated screen packing module disposed on the support ring, and
wherein the corrugated screen packing module comprises a corrugated screen layer comprising a plurality of corrugated structures, each of the corrugated structures being configured and dimensioned to pass through an access opening having a first area A1, and
wherein the first area A1 is smaller than a second area A2 defined by the inner surface of the outer wall in a plane perpendicular to the longitudinal axis.

17. The carbon capture system of claim 16, wherein the access opening has a set of dimensions including a range in a range from 400 mm to 1200 mm.

18. The carbon capture system of claim 16, wherein the absorption column comprises the access opening formed in the outer wall, the floor, or the ceiling.

19. The carbon capture system of claim 16, wherein the corrugated screen packing module comprises a first grid layer, the first grid layer comprising a plurality of rods or bars arranged in a grid pattern, each of the plurality of rods or bars of the first grid layer being configured and dimensioned to pass through the access opening.

20. The carbon capture system of claim 16, wherein the dimension in the range from 400 mm to 1200 mm is a maximum dimension of the access opening.

21. The absorption column of claim 1, wherein the corrugated screen packing module comprises a module access opening formed therethrough.

22. The method of claim 10, wherein the corrugated screen packing module comprises a module access opening formed therethrough.
